(19) United States
(12) Patent Application Publication
(10) Pub. No.: US 2007/0277099 A1
(43) Pub. Date: Nov. 29, 2007

(54) PAGE SOURCE DATA GENERATION METHOD, PAGE SOURCE DATA GENERATION SYSTEM, AND PROGRAM

(76) Inventors: Kojiro NAKAYAMA, Yokohama (JP); Yutaka Kudo, Yokohama (JP); Futoshi Haga, Sagamihara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/622,632

(22) Filed: Jan. 12, 2007

(30) Foreign Application Priority Data
May 23, 2006 (JP) JP2006-143134

(51) Int. Cl. G06F 17/00

(52) U.S. Cl. 715/530

(57) ABSTRACT

A server device is provided that requests a web service to provide services, and the server device prepares templates each corresponding to an area of web services that are provided. The server device adds input areas and input item names of data, required by a web service providing device of a web service specified by a user who operates a client terminal, to a template. In addition, an input condition for each input item, which is defined as a policy by the service providing device of the web service specified by the user, is added to the template. In this way, information displayed on a data input screen, which is sent to the user's client terminal, is completed as data, such as HTML-coded data, which can be processed by a browser running on the user terminal.

### INCORPORATION BY REFERENCE

The present application claims priority from Japanese application JP2006-143134 filed on May 23, 2006, the content of which is hereby incorporated by reference into this application.

### BACKGROUND OF THE INVENTION

The present invention relates to a page source data generation method, a page source data generation system, and a program for entering data.

Recently, the information processing service provides many web services. A service provider that provides web services defines a condition (also called a policy) for data included in a message (called a SOAP message) defined by SOAP (Simple Object Access Protocol). Therefore, when creating a SOAP message, a system that uses web services is required to check if the data satisfies the condition. Conventionally, several data checking methods have been proposed. For example, a method for checking if data entered in an input form on the screen satisfies a predetermined condition is described in Non-Patent Document 1, Section “Pluggable Validators” in “Struts Validator Guide” published by The Apache Software Foundation. (online, searched on Jan. 23, 2006, Internet <URL: http://struts.apache.org/struts-doc-1.2.x/userGuide/dev_validator.html>)

However, the technology disclosed in Non-Patent Document 1 has the following problem. That is, when the user who wants to receive a web service (for example, hotel booking, airplane seat reservation) enters data from a client terminal, the condition required for the entered data must be prepared in advance for each provided service as screen information that will be sent to the client terminal. In addition, each web service has a policy that defines a condition for data entered by the user and, for example, the maximum number of characters of a user name varies according to the web service. So, preparing screen information, which is sent to a client terminal for each policy, requires time and labor.

Another problem is that there is a high possibility that some condition defined as a policy, for example, the type of credit card, is changed frequently. This makes it difficult to prepare correct screen information that reflects the modified contents.

In view of the foregoing, it is an object of the present invention to provide a page source data generation method, a page source data generation system, and a program that can generate page source data based on a data condition used for entering data required for receiving a service provided as web services.

### SUMMARY OF THE INVENTION

To solve the problems described above, a server device is provided that requests a web service to provide services, and the server device prepares templates each corresponding to an area of web services that are provided.

The server device adds input areas and input item names of data, required by a web service providing device of a web service specified by a user who operates a client terminal, to a template.

In addition, an input condition for each input item, which is defined as a policy by the service providing device of the web service specified by the user, is added to the template. In this way, information displayed on a data input screen, which is sent to the user's client terminal, is completed as data, such as HTML-coded data, which can be processed by a browser running on the user terminal.

The user enters data, required for a service request of a desired web service, by entering data, such as a name, a telephone number, and an address that satisfy the input conditions, on the data input screen displayed on the client terminal. In response to the data from the client terminal, the server device converts the data to data in a format, for example, an XML format, acceptable by the service providing device that provides the web service. In this way, the server device can send the data to the service providing device, wherein the data satisfies the condition described in a policy under which the service providing device can accept the service request from the user.

Although the creation of a data input screen does not always require a template, the server device may have a data input screen creation policy that is a rule for entering the input items, such as the description sequence and the screen layout position. The data required for receiving the service of the service providing device that provides the web service, if available from the service providing device, allows data input screen information, which reflects the policy of the service providing device, to be generated directly.

According to the present invention, screen input data can be generated according to the condition of a service providing device used in a web service.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an example of the architecture of an information processing system in an embodiment.

FIG. 2 is a block diagram showing an example of the architecture of a server device 20.

FIG. 3 is a block diagram showing an example of the detailed architecture of the server device 20.

FIG. 4 is a block diagram showing an example of the architecture of a web service providing device 30.

FIG. 5 is a block diagram showing an example of the architecture of a client device 10.

FIG. 6 is a diagram showing an example of the architecture of a provider database 251.

FIG. 7 is a diagram showing an example of a policy file 266.

FIG. 8 is a diagram showing an example of a field definition database 252.

FIG. 9 is a diagram showing an example of a field mapping database 253.

FIG. 10 is a diagram showing an example of condition data 280.

FIG. 11 is a diagram showing an example of an input assist pattern database 254.

FIG. 12 is a diagram showing an example of a template database 255.

FIG. 13 is a diagram showing an example of booking processing in the system in the embodiment.

FIG. 14 is a diagram showing an example of an input screen 71 on which a web service list is displayed.

FIG. 15 is a flowchart showing an example of page source data generation processing based on the policy file.

FIG. 16 is a diagram showing an example of a template corresponding to a request service ID.

FIG. 17 is a flowchart showing an example of extension tag replacement processing.

FIG. 18 is a flowchart showing an example of <display>tag replacement processing.

FIG. 19 is a flowchart showing an example of <dform>tag replacement processing.

FIG. 20 is a flowchart showing an example of <hint>tag replacement processing.

FIG. 21 is a flowchart showing an example of <checkmodule>tag replacement processing.

FIG. 22 is a diagram showing an example of page source data 73.

FIG. 23 is a diagram showing an example of an input screen 74 displayed on the client device 10.

FIG. 24 is a diagram showing an example of a screen acquisition request that includes request data sent from the client device 10.

FIG. 25 is a diagram showing an example of a SOAP envelope.

FIG. 26 is a diagram showing an example of the field definition database 252.

FIG. 27 is a diagram showing an example of the field mapping database 253.

FIG. 28 is a diagram showing an example of a template 77.

FIG. 29 is a diagram showing an example of page source data 78.

FIG. 30 is a diagram showing an example of an input screen 79 displayed based on the page source data 78.

### DESCRIPTION OF THE EMBODIMENTS

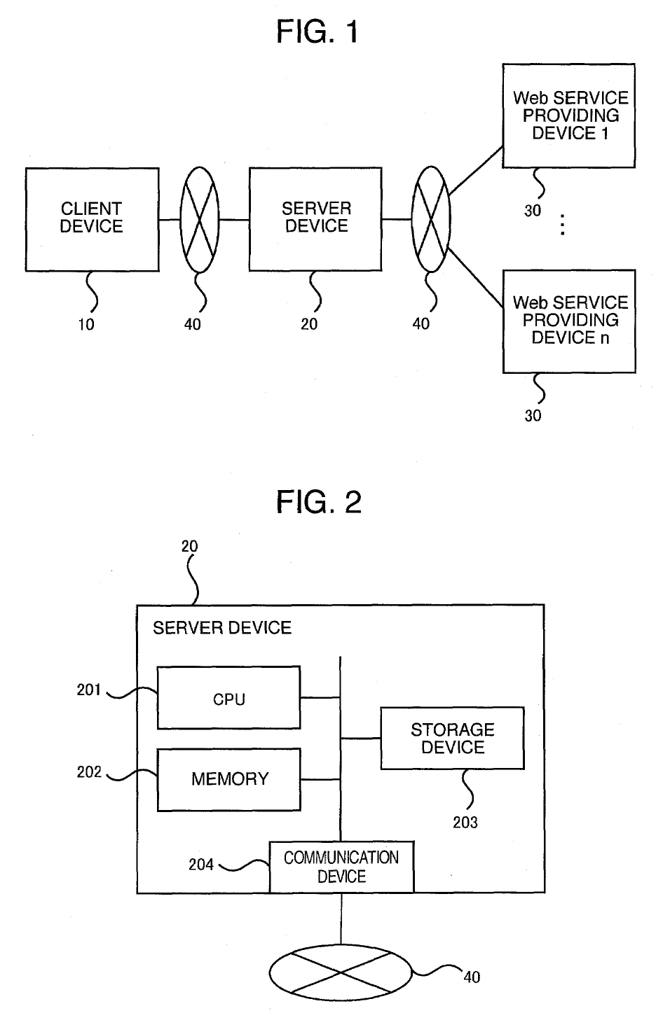

FIG. 1 is a diagram showing the general architecture of an information processing system in this embodiment. The following describes the information processing system in this embodiment with a hotel booking system as an example.

As shown in FIG. 1, the information processing system in this embodiment comprises a client device 10, a server device 20, and web service providing devices 30 (1, . . . , n). The client device 10 and the server device 20 are connected, and the server device 20 and the web service providing devices 30 are connected, each via a communication network 40 for communication. The communication network 40 is, for example, the Internet, a leased line, or a frame relay network.

Referring to FIG. 1, there are two separate communication networks: one is the communication network 40 that connects the client device 10 and the server device 20 and the other is the communication network 40 that connects the server device 20 and the web service providing devices 30. Instead of this, the client device 10, the server device 20, and the web service providing devices 30 may also be connected to one communication network 40 such as the Internet. The client device 10, the server device 20, and the web service providing devices 30 may be separate computers or may be one or more computers.

The web service providing device 30 is a computer operated by a hotel for providing the web service that accepts hotel booking requests. A workstation or a personal computer can be used as the web service providing device 30. The web service providing device 30 accepts a hotel booking request in the form of a message described in XML (Extensible Markup Language) and defined by SOAP (Simple Object Access Protocol) (hereinafter, this message is called a SOAP message). In this embodiment, the web service refers to the information processing for a SOAP message.

The client device 10 is a computer used by the user of the booking service. A personal computer, a mobile phone, a PDA (Personal Digital Assistant), or a workstation can be used as the client device 10. The client device 10 has a web browser which allows the user to perform operation to access the server device 20.

The server device 20, which functions as a web server, is a computer that uses the web service, provided by the web service providing device 30, to provide the user with the booking service. A workstation or a personal computer can be used as the server device 20. In response to an access from the client device 10, the server device 20 generates page source data, which is used to display the screen to allow the user to enter data necessary for hotel booking, and sends the generated page source data back to the client device 10. In this embodiment, the page source data generated by the server device 20 is a so-called web page described in HTML (Hyper Text Markup Language). The server device 20 also receives request data, which is necessary for booking, from the client device 10, generates a SOAP message based on the received request data, and sends the generated SOAP message to the web service providing device 30 to perform hotel booking.

The data (hereinafter called request data) included in a SOAP message and sent to the web service providing device 30 must satisfy the various conditions (hereinafter called a policy). For example, if the phone number is necessary for the booking, the request data about the user's phone number must be specified.

Also, if only two types of credit cards, ABC and XYZ, are acceptable, one of ABC and XYZ must be selected for the request data about the credit card type.

The policy for such request data is described in a file (hereinafter called a policy file). The policy can be described using policy languages such as WS-Policy and WS-PolicyConstraints. The policy file is managed by the web service providing device 30. As will be described later, the server device 20 acquires the policy file from the web service providing device 30 and generates page source data, which includes user help information, so that the user can enter data that follows the policy of each hotel.

In this embodiment, there are two types of information for helping the user to enter data that follows the policy of a hotel: one is the description (hereinafter also called a hint) of policy data entered in an entry column (also called an input field) of the page source data and the other is a program (hereinafter called a check module) executed in the client device 10 for checking if entered data follows the policy. In this embodiment, it is assumed that the check module is coded in the JavaScript language.

FIG. 2 shows an example of the hardware architecture of the server device 20. The hardware architecture of the client device 10 and the web service providing device 30 is the same as that of the server device 20 shown in FIG. 2. As shown in FIG. 2, the server device 20 comprises a CPU 201, a memory 202, a storage device 203, and a communication device 204. The storage device 203 is a hard disk drive, a CD-ROM drive, or a flash memory in which programs and data are stored. The CPU 201 reads a program from the storage device 203 into the memory 202 to implement various functions. The communication device 204 is an interface for connection to the communication network 40. A network adapter for connection to the Ethernet (registered trademark) or a modem for connection to the public telephone line can be used as the communication device 204. The server device 20 may also have an input device such as a keyboard or a mouse and an output device such as a display or a printer.

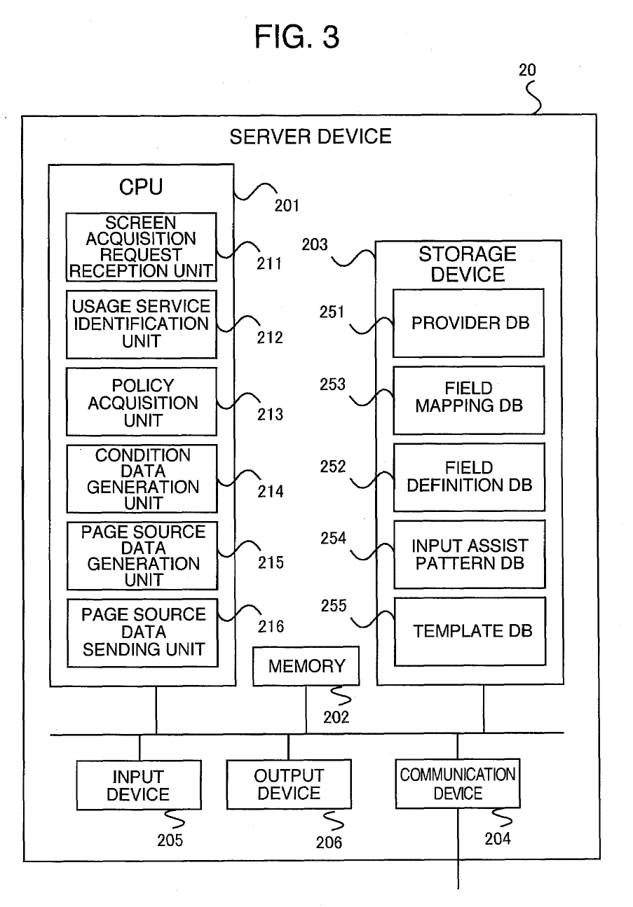

FIG. 3 is a diagram showing an example of the software architecture of the server device 20. As shown in the figure, the server device 20 comprises a screen acquisition request reception unit 211, a usage service identification unit 212, a policy acquisition unit 213, a condition data generation unit 214, a page source data generation unit 215, a page source data sending unit 216, a provider database 251, a field definition database 252, a field mapping database 253, an input assist pattern database 254, and a template database 255. The functional units 211-216 described above are implemented by the CPU 201, included in the server device 20, that reads programs from the storage device 203 into the memory 202 and executes them. The databases 251-255 are stored in the memory 202 or in the storage area of the storage device 203.

The server device 20 further comprises input devices 205 such as a keyboard and a mouse, output devices 206 such as a display and a printer, and a communication device 204 used to connect to the network.

The screen acquisition request reception unit 211 receives a command (hereinafter called a screen acquisition request), which acquires page source data necessary to enter request data, from the client device 10. The screen acquisition request is, for example, an HTTP (HyperText Transfer Protocol) request.

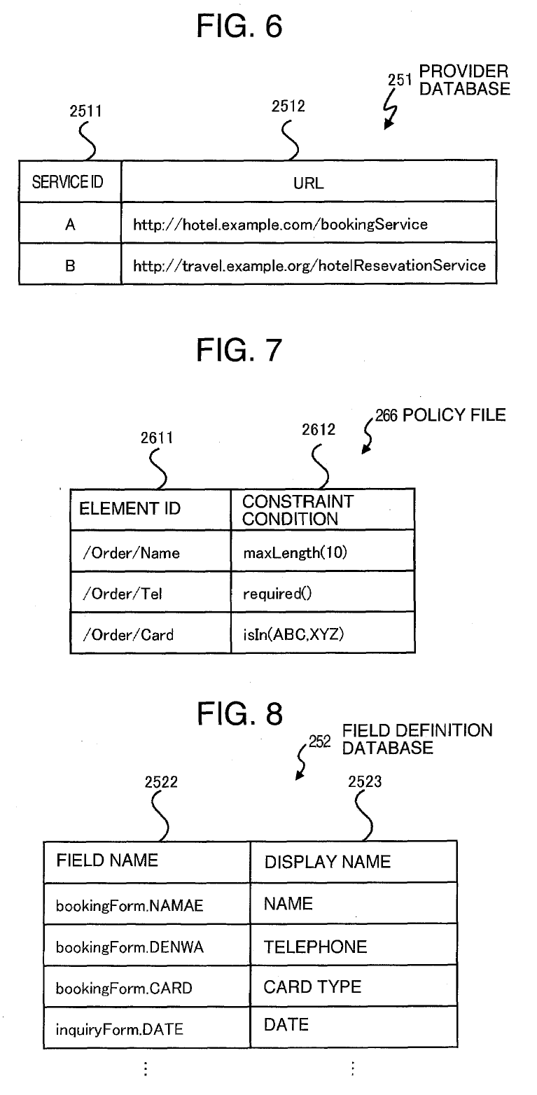

The provider database 251 stores information identifying a web service. FIG. 6 shows an example of the architecture of the provider database 251. As shown in the figure, the provider database 251 stores a service ID 2511 and a URL 2512 of its corresponding web service provided by the web service providing device 30. The service ID 2511 is the identifier identifying a web service, and the URL 2512 is information identifying the network site where the web service is provided.

The usage service identification unit 212 identifies a web service specified by the user. In this embodiment, if a screen acquisition request sent from the client device 10 includes a service ID, the usage service identification unit 212 acquires the URL of the web service, corresponding to the service ID, from the provider database 251.

The policy acquisition unit 213 acquires a policy file 266 from the web service providing device 30. In this embodiment, the policy acquisition unit 213 sends a command (hereinafter called a policy request), used to acquire the policy file 266, to the web service identified by the usage service identification unit 212, and receives the policy file 266 sent from the web service providing device 30 in response to the policy request. The received policy file 266 is stored in the storage area (policy data storage area) of the memory 202.

FIG. 7 shows an example of the policy file 266. As shown in the figure, the policy file 266 contains an element ID 2611 and its corresponding constraint condition 2612. The element ID 2611 is information identifying the request data included in a SOAP message. Because a SOAP message is described in XML, the element ID 2611 is represented by the XML path in the SOAP message. The constraint condition 2612 is a condition for the request data identified by the element ID 2611. In this embodiment, the constraint condition 2612 is described as a function which is one of the following three: “maxLength(data length)” specifying the maximum data length allowed for the request data, “required( )” specifying that the request data cannot be omitted (for example, the data length is larger than “0”), and “isIn (option list)” specifying that the request data be selected from predetermined items. In the example in FIG. 7, the following policy is set. That is, the request data identified by “/Order/Name” is “10 characters or less in the data length”, the request data identified by “/Order/Tel” is “required not to be omitted”, and the request data identified by “/Order/Card” is either “ABC” or “XYZ”.

Although represented in a tabular form as shown in FIG. 7 for simplicity in this embodiment, the policy file 266 may also be described in XML.

Although the constraint condition is limited in this embodiment to the three described above, the present invention does not limit the constraint types. For example, “minLength(n)” may be used to specify the minimum value (n) of the data length of the request data, “lessThan(n)” may be used to specify that numeric request data be less than a predetermined threshold n, and “before(yyyy/mm/dd)” may be used to specify that the request data, which is date data, be before the date yyyy/mm/dd.

The field definition database 252 stores information (hereinafter called field definition information) on the input fields provided in the input screen of the request data sent to the web service providing device 30. FIG. 8 shows an example of the architecture of the field definition information stored in the field definition database 252. As shown in the figure, the field definition information comprises a field name 2522 and a display name 2523. The field name 2522 is information identifying an input field. Because page source data is described in HTML in this embodiment, the field name 2522 is the name (a value specified for the name attribute) of an HTML tag (for example, <input>tag or <textarea>tag) indicating an input field. The display name 2523, the name of the request data entered in the input field, is described in any representation format displayed on the screen of the client device 10.

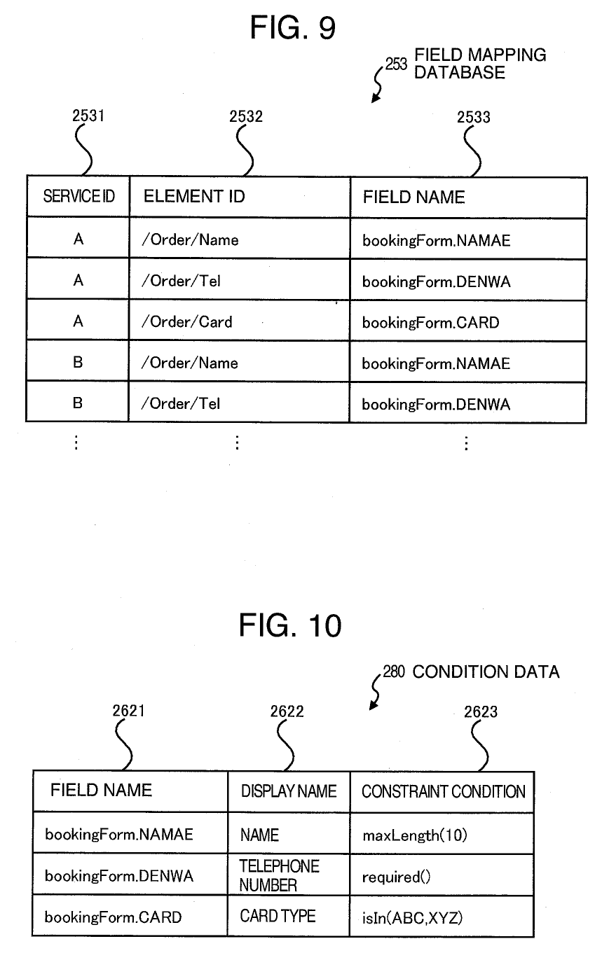

The field mapping database 253 stores information (hereinafter called field mapping information) that indicates the correspondence between an input field and request data included in a SOAP message sent to the web service providing device 30. FIG. 9 shows an example of the architecture of field mapping information stored in the field mapping database 253. As shown in the figure, the field mapping information establishes the correspondence between a service ID 2531, an element ID 2532, and a field name 2533.

The condition data generation unit 214 generates information indicating the conditions for the input fields (hereinafter called condition data). FIG. 10 shows an example of the architecture of condition data 280 generated by the condition data generation unit 214. As shown in the figure, the condition data 280 comprises a field name 2621, a display name 2622, and a constraint condition 2623. More specifically, the condition data generation unit 214 reads the field definition information from the field definition database 252 and generates the condition data 280 including the field name 2522 and the display name 2523 of the field definition information that were read. The condition data generation unit 214 performs the following processing for each policy included in the acquired policy file 266.

First, the condition data generation unit 214 checks the field mapping information, included in the field mapping database 253, and acquires the field mapping information whose service ID 2531 matches the service ID value of a web service identified by the usage service identification unit 212. Next, the condition data generation unit 214 acquires the fields which are included in the acquired field mapping information and whose element ID 2532 has a value that matches the element ID 2611 of the policy. The condition data generation unit 214 sets the value, which is stored in the constraint condition 2612 of the policy, in the constraint condition 2623 of the condition data 280 whose field name matches the value of the field name 2533 of the field mapping information acquired as described above. In this way, the condition data generation unit 214 generates the condition data 280. The condition data 280 generated by the condition data generation unit 214 is used for generating the page source data that will be described later.

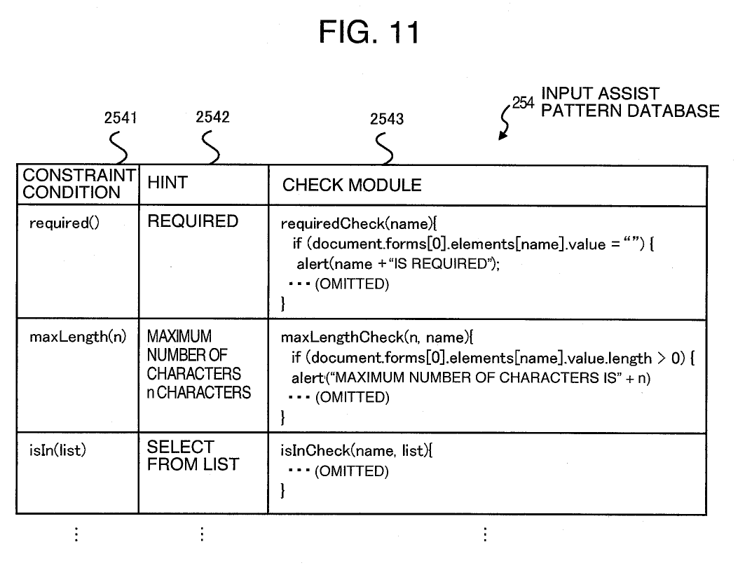

The input assist pattern database 254 (corresponding to the hint database of the present invention) stores information (hereinafter called input assist pattern information) that helps the user to enter request data, which satisfies the policy, on the request data input screen. FIG. 11 shows an example of the architecture of the input assist pattern information stored in the input assist pattern database 254. As shown in the figure, the input assist pattern information includes a constraint condition 2541, a hint 2542, and a check module 2543. The constraint condition 2541 is information (policy representation data) indicating a condition represented in the format used to describe the condition for request data in the policy file 266. The hint 2542 is information (screen representation data) indicating a condition represented in the format used to display the condition for request data on the screen. As will be described alter, the check module 2543 is inserted in page source data when the page source data is generated.

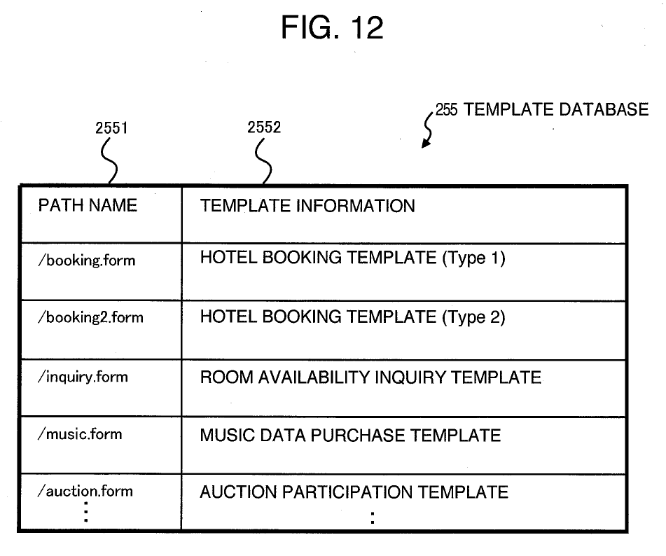

The template database 255 stores the templates of page source data generated by the server device 20. FIG. 12 shows an example of the architecture of the template database 255. As shown in the figure, the template database 255 stores a pathname 2551 and its corresponding template information 2552 that is used as the template of page source data corresponding to each of the service fields such as hotel booking, room availability inquiry, music data purchase, and auction participation. The pathname 2551 is information identifying the location in the server device 20 where the template is stored. A template need not be identified uniquely for each service area but multiple templates, such as hotel booking templates, may be used.

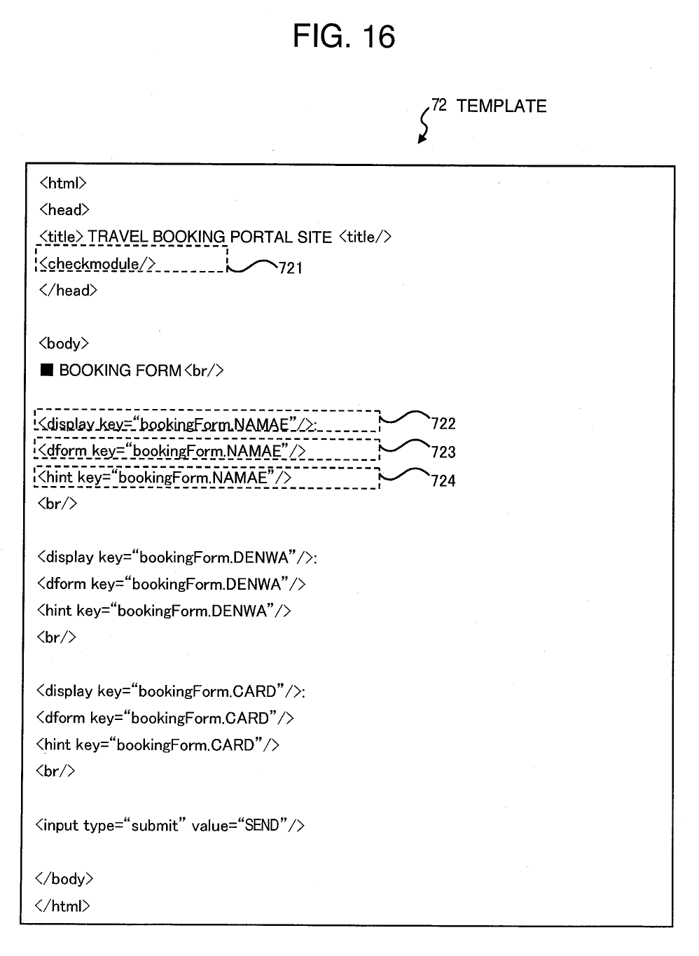

Although a template is described in the HTML format, the four tags not defined in HTML, that is, the <checkmodule>tag, <display>tag, <dform>tag, and <hint>tag, may also be included (hereinafter, these four tags are called extension tags). FIG. 16 shows an example of a template. In the example in FIG. 16, the four extension tags, <checkmodule>tag, <display>tag, <dform>tag, and <hint>tag, are included. The <display>tag, <dform>tag, and <hint>tag have the key attribute for which a value indicating a field name is specified. For example, a <display>tag 722 in FIG. 16 has the key attribute having the value of “bookingForm.NAMAE”. If the <checkmodule>tag is included in the template, this tag is replaced by a check module 2543, stored in the input assist pattern database 254 described above, according to the constraint condition 2623 of the condition data 280. If the <display>tag is included in the template, this tag is replaced by the display name 2622 of the condition data 280 according to the value specified for the key attribute. If the <dform>tag is included in the template, this tag is replaced by data (hereinafter called form data) for displaying the input field of the screen according to the constraint condition 2623 of the condition data 280. If the <hint>tag is included in the template, this tag is replaced by the hint 2542, stored in the input assist pattern database 254 described above, according to the constraint condition 2623 of the condition data 280. The replacement processing will be described later.

To distinguish between a tag defined by HTML and an extension tag described above, a name space may be used for the name of an extension tag.

The page source data generation unit 215 generates page source data in response to a screen acquisition request received by the screen acquisition request reception unit 211. The page source data generation unit 215 acquires a template, corresponding to the pathname included in the screen acquisition request, from the template database 255 and replaces the above-described extension tags, included in the acquired template, to generate page source data. The generation processing of page source data will be described later in detail.

The page source data sending unit 216 sends page source data, generated by the page source data generation unit 215, to the client device 10 as a response to the screen acquisition request received by the screen acquisition request reception unit 211.

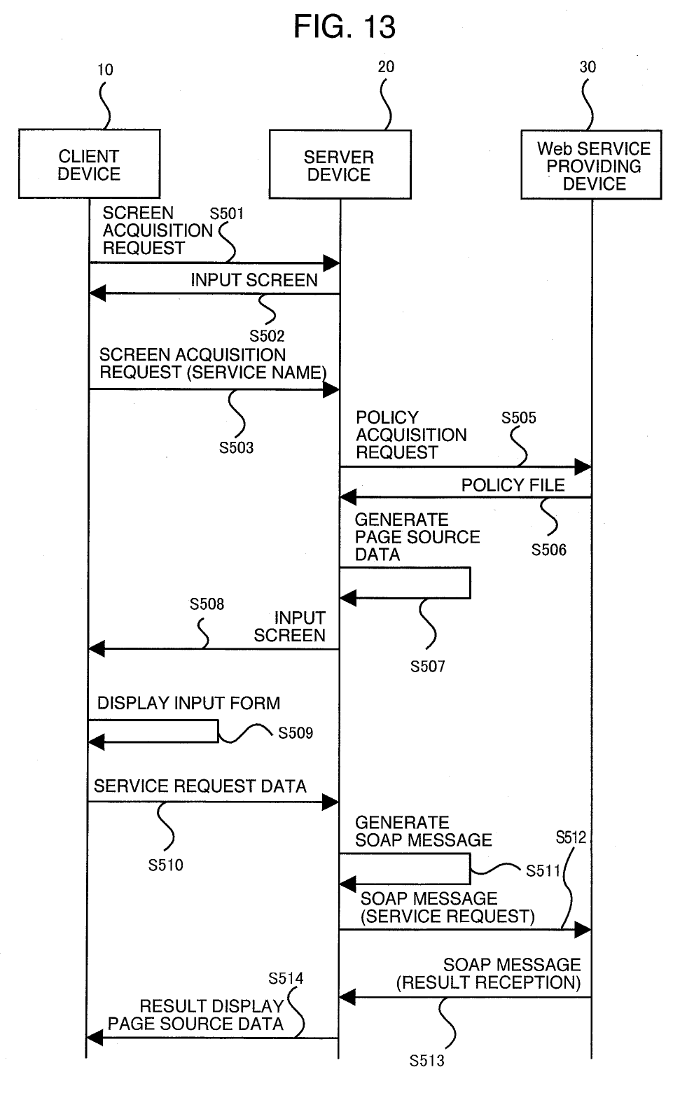

The following describes the processing of the information processing system in this embodiment. FIG. 13 is a diagram showing an example of the flow in which booking is performed for the user in the information processing system.

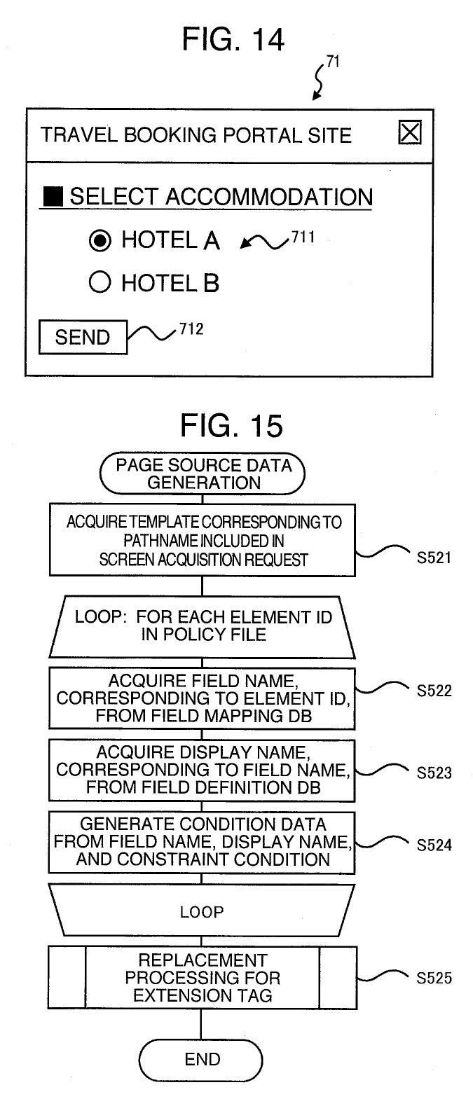

The client device 10 sends a screen acquisition request to the server device 20 via HTTP (S501). The screen acquisition request includes a pathname indicating the location of the resource in the server device 20. The server device 20 sends the page source data of an input screen, from which a web service is selected for booking, to the client device 10 according to the pathname included in the screen acquisition request sent from the client device 10 (S502). FIG. 14 shows an example of an input screen 71 on which a list of web services is displayed.

In the example in FIG. 14, the input screen 71 has a selection field 711 that includes the names of hotels that provide a web service. From the selection field 711, the user can select one of the two, “Hotel A” and “Hotel B”. The radio buttons in the selection field 711 are associated with service IDs, named A and B, respectively. When the user presses a Send button 712, the client device 10 sends a screen acquisition request, for which the service ID corresponding to the selected radio button is specified, to the server device 20 (S503). The screen acquisition request also includes a pathname indicating the location of the resource in the server device 20.

In response to the screen acquisition request, for which the service ID is specified, from the client device 10, the server device 20 references the provider database 251 to identify the web service providing device 30 corresponding to the service ID (hereinafter called a request service ID) specified for the received screen acquisition request. The server device 20 sends a policy acquisition request to the identified web service providing device 30 (S505).

In response to the policy acquisition request, the web service providing device 30 sends the policy file 266, managed by the web service providing device 30, to the server device 20 (S506).

The server device 20 receives the policy file from the web service providing device 30 and generates page source data according to the received policy file (S507).

FIG. 15 shows the flow of page source data generation processing that is performed based on the policy file.

The screen acquisition request sent from the client in S503 includes a pathname indicating the location of the resource in the server device 20. The server device 20, which receives the screen acquisition request in S503, acquires the template, corresponding to the pathname 2551 that matches the pathname included in the screen acquisition request sent from the client, from the template database 255 (S521). FIG. 16 shows an example of the template corresponding to the pathname.

The server device 20 performs the following processing for each of the element IDs 2611 included in the policy file 266 received from the web service providing device 30.

The server device 20 acquires the field name 2533, corresponding to the request service ID and the element ID 2611, from the field mapping database 253 (S522). The server device 20 acquires the display name 2523, corresponding to the acquired field name 2533, from the field definition database 252 (S523). The server device 20 establishes the correspondence among the field name 2533, display name 2523, and the constraint condition 2612 corresponding to the element ID 2611 of the policy file 266, and generates the condition data 280 (S524).

The server device 20 repeats the above processing to generate the condition data 280 for all element IDs 2611 included in the policy file 266, and embeds the field name, display name, and constraint condition, which correspond to each of the element IDs defined in the policy file 266, into the template.

A template 72 shown in the example in FIG. 16 includes the extension tags <checkmodule>tag 721, <display>tag 722, <dform>tag 723, and <hint>tag 724. The server device 20 performs replacement processing for the extension tags included in the acquired template (S525).

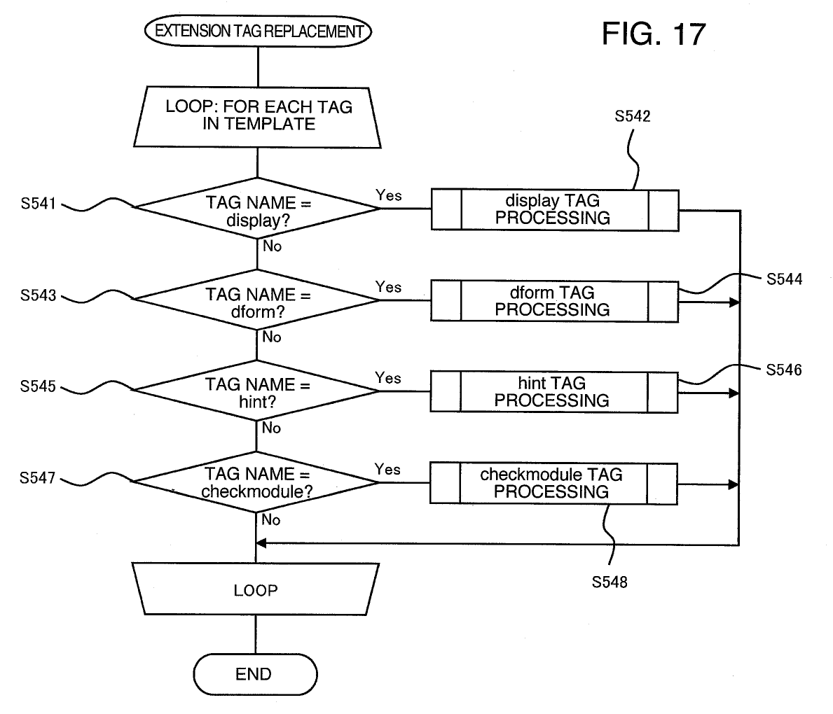

FIG. 17 shows the flow of the extension tag replacement processing. The server device 20 performs the following processing for the tags included in the template.

If the tag is the <display>tag (S541: YES), the server device 20 performs the <display>tag replacement processing (S542).

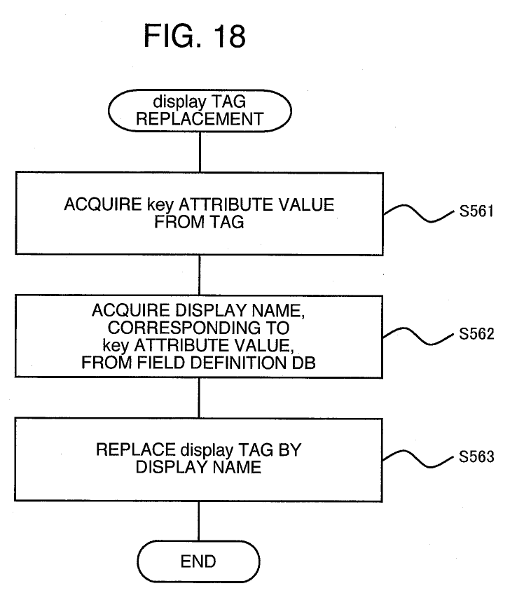

FIG. 18 shows the flow of the <display>tag replacement processing. The server device 20 acquires the key attribute value of the <display>tag (S561), acquires the display name 2523, corresponding to the key attribute value, from the field definition database 252 (S562), and replaces the <display>tag in the template by the acquired display name 2523 (S563).

If the tag is the <dform>tag (S543: YES), the server device 20 performs the <dform>tag replacement processing (S544).

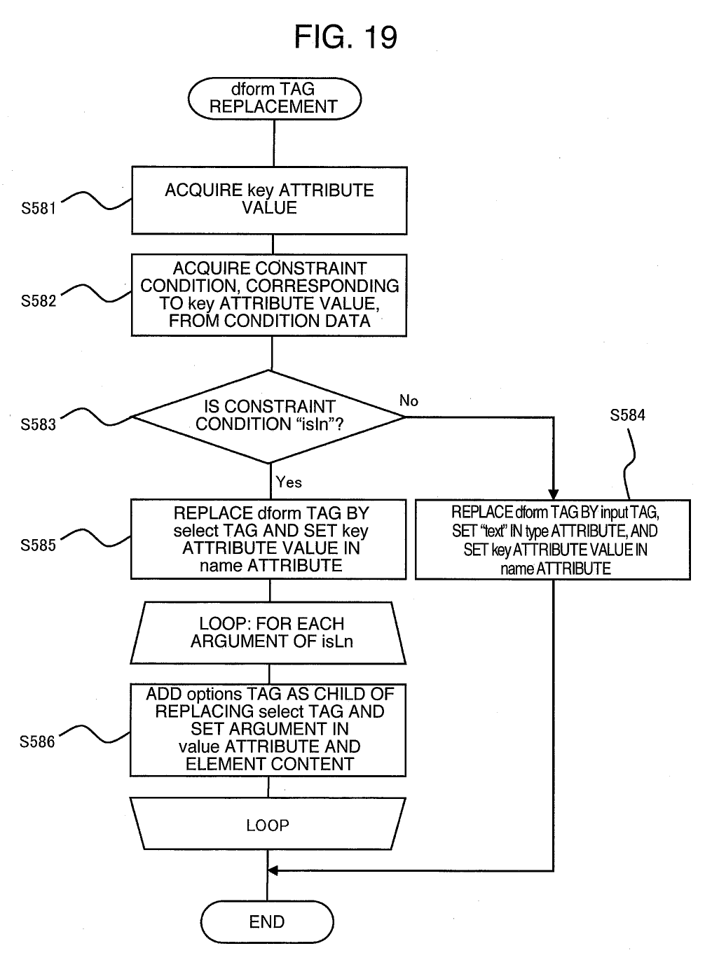

FIG. 19 shows the flow of the <dform>tag replacement processing. The server device 20 acquires the key attribute value of the <dform>tag (S581) and acquires the constraint condition 2623, corresponding to the key attribute value, from the condition data 280 (S582). If the constraint condition 2623 is not “isIn” that selects one of multiple selections (S583: NO), the server device 20 replaces the <dform>tag by the <input>tag, sets the above-described key attribute value in the name attribute of the <input>tag that has replaced the <dform>tag, and sets “text” in the type attribute (S584).

On the other hand, if the constraint condition 2623 is “isIn” (S583: YES), the server device 20 replaces the <dform>tag by the <select>tag and sets the above-described key attribute value in the name attribute of the <select>tag that has replaced the <dform>tag (S585). For each argument of isIn( ), the server device 20 adds the <option>tag as the child of the <select>tag, which has replaced the <dform>tag, and sets the argument of isIn( ) in each of the value attribute of the added <option>tag and the content of the tag (S586).

If the tag is the <hint>tag (S545: YES), the server device 20 performs the <hint>tag replacement processing (S546).

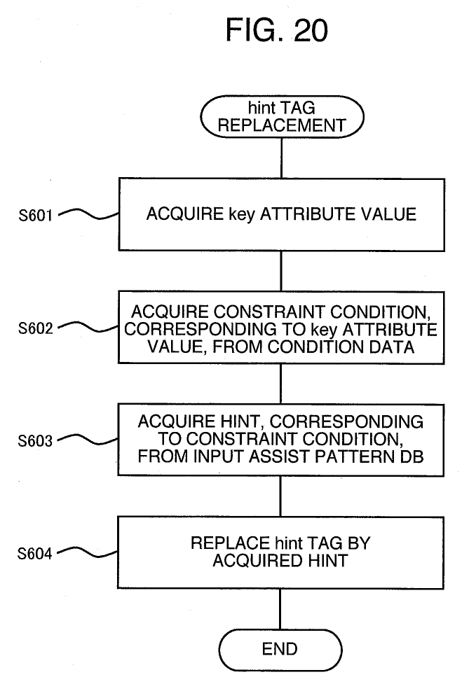

FIG. 20 shows the flow of the <hint>tag replacement processing. The server device 20 acquires the key attribute value of the <hint>tag (S601) and acquires the constraint condition 2623, corresponding to the key attribute value, from the condition data 280 (S602). The server device 20 acquires the hint 2542, corresponding to the constraint condition 2541, from the input assist pattern database 254 (S603), and replaces the <hint>tag by the hint 2542 (S604).

If the tag is the <checkmodule>tag (S547: YES), the server device 20 performs the <checkmodule>tag replacement processing (S548).

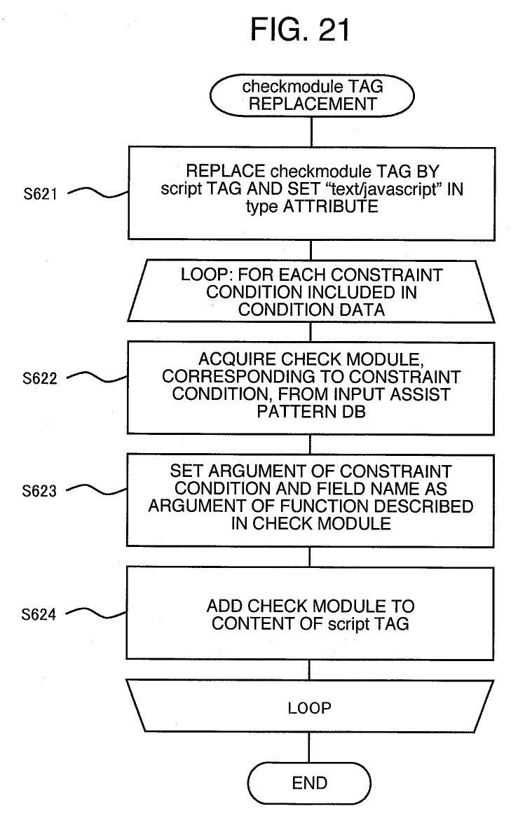

FIG. 21 shows the flow of the <checkmodule>tag replacement processing. The server device 20 replaces the <checkmodule>tag with the <script>tag and sets “text/javascript” in the type attribute of the <script>tag that has replaced the <checkmodule>tag (S621). For each of the constraint conditions 2623 included in the condition data 280, the server device 20 reads the check module 2543, corresponding to the constraint condition 2623, from the input assist pattern database 254 (S622) and adds the argument of the function described in the constraint condition 2623 and the above-described field name 2621 as the arguments of the function described in the check module 2543 that was read (S623). The server device 20 inserts the check module 2543, to which the arguments have been added, as the content of the <script>tag described above (S624).

As described above, the server device 20 performs the page source data generation processing (S507) in FIG. 13 to generate page source data in which the user help information is embedded so that the user can enter request data satisfies the policy and that is necessary to perform hotel booking.

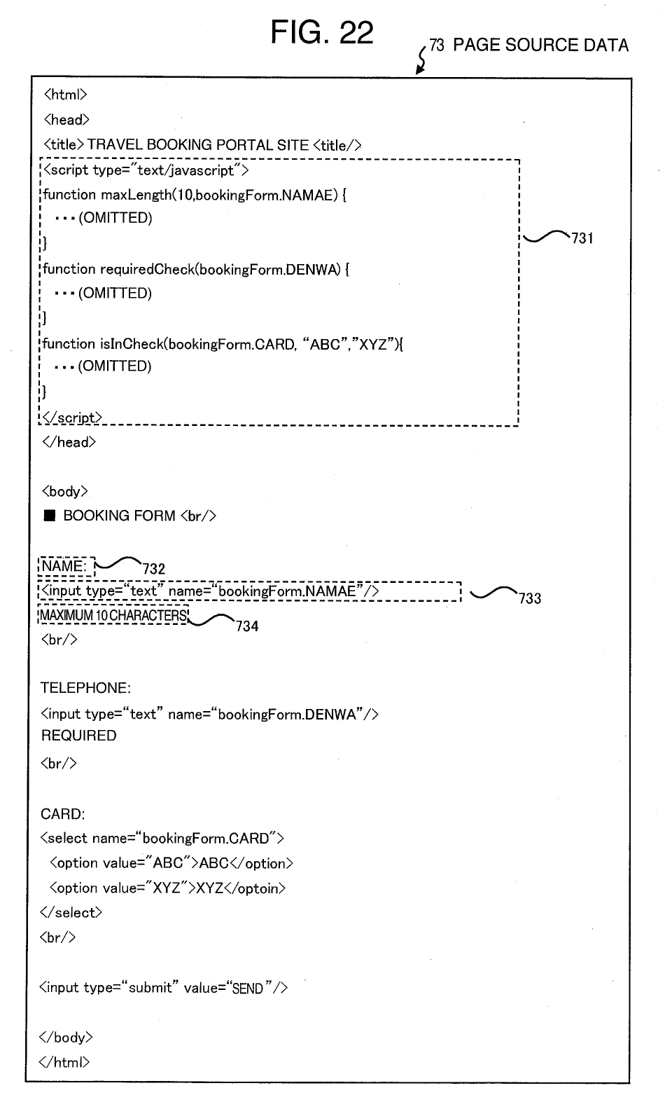

FIG. 22 shows an example of page source data 73 generated as a result of the above processing performed for the template 72 shown in FIG. 16.

In the page source data 73 in the example shown in FIG. 22, the <checkmodule>tag 721 (<checkmodule/>) included in the template 72 in FIG. 16 is replaced by the <script>tag whose content is a JavaScript-coded check module. The <display>tag 722 (<display key=“bookingForm.NAMAE”/>) is replaced by a message 732 that is “Name”, and the <dform>tag (<dform key=“bookingForm.NAMAE”>) is replaced by the <input>tag (<input type=“text” name=“bookingForm.NAMAE”/>). The <hint>tag (<hint key=“bookingForm.NAMAE”/>) is replaced by a message 733 that is “Maximum 10 characters”. In addition, the <dform>tag (<dform key=“bookingForm.CARD”/>) for “CARD”, whose constraint condition 2623 is isIn( ) in the condition data 280, is replaced by the <select>tags for which the <option>tags of “ABC” and “XYZ” are specified (<select name=“bookingForm.CARD”><option value=“ABC”>ABC</option><option value=“XYZ”>XYZ</option></select>).

The server device 20 sends the page source data, generated as described above, to the client device 10 (S508).

In response to the page source data from the server device 20, the client device 10 displays the request data input screen based on the received page source data and accepts the data entered by the user (S509).

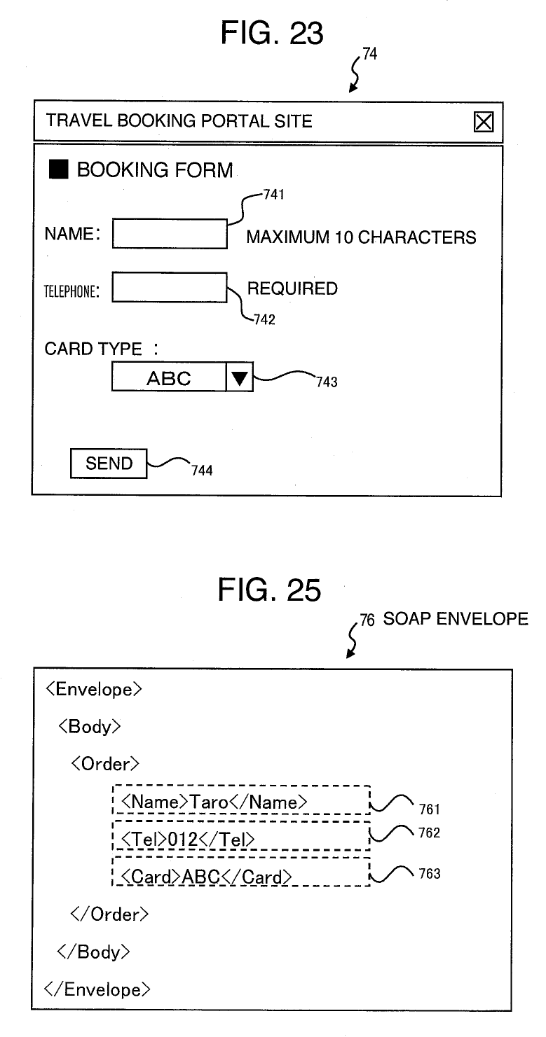

FIG. 23 shows an example of an input screen 74 displayed on the client device 10 based on the page source data (FIG. 22) generated by replacing the extension tags. As shown in the figure, the input screen 74 has a name input field 741, a telephone number input field 742, and a credit card type input field 743. Beside the input fields, the names of the input fields generated by replacing the <display>tags, as well as the hint and the list box for the constraint condition, are also displayed. When the user enters the values in the name input field 741 and the telephone number input field 742, selects the type of card from the card type input field 743, and presses the Send button 744, the client device 10 sends a screen acquisition request, which includes the entered request data, to the server device 20 via HTTP (S510).

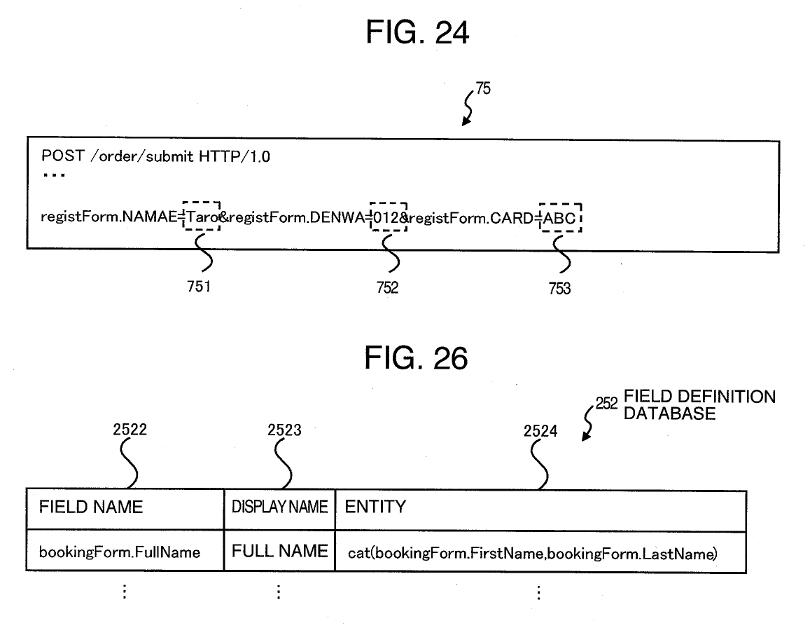

FIG. 24 shows an example of a screen acquisition request that includes request data sent from the client device 10. A screen acquisition request 75 in FIG. 24 shows that the name input field 741 indicated by “bookingForm.NAMAE” contains “Taro” (751), that the telephone number input field 742 indicated by “bookingForm.DENWA” contains “012” (752), and that “ABC” is selected from the credit card type selection input field 743 indicated by “bookingForm.CARD” (753).

The server device 20 generates a SOAP message based on the screen acquisition request, which includes the request data, from the client device 10. For example, the server device 20 acquires an element ID, which corresponds to “bookingForm.NAMAE” indicating the name input field 741 and the request service ID, from the field mapping database 253 and generates a SOAP message with the request data set in the content of the tag whose name is the acquired element ID (S511).

FIG. 25 shows an example of request data (also called SOAP envelope) included in a SOAP message and described in the XML format. The figure shows that, in the SOAP envelope 76 shown in the figure, the request data 751 (Taro) of the screen acquisition request 75 shown in FIG. 24 is set in the content of an element 761 identified by “/Order/Name” corresponding to the input field of “bookingForm.NAMAE”. In addition, request data 752 (012) is set in the content of an element 762 identified by “/Order/Tel” corresponding to “bookingForm.DENWA”, and request data 753 (ABC) is set in the content of an element 763 identified by “/Order/Card” corresponding to “bookingForm.CARD”.

The server device 20 sends the generated SOAP message to the web service providing device 30 (S512). The web service providing device 30 performs the hotel booking processing in response to the SOAP message received from the server device 20. As described above, the information processing system in this embodiment performs booking for the user.

The server device 20 in this embodiment can generate page source data that includes the user help information so that the received data satisfies a policy included in the policy file 266. This means that the data entered into the client device 10 is expected to satisfy the policy and, therefore, the server device 20 can send a SOAP message, in which the request data satisfying the policy is set, to the web service providing device 30. Thus, the server device 20 can avoid a condition in which, if user-entered request data does not satisfy a policy request, the request data once sent to the web service providing device is rejected by the web service providing device and, as a result, the user is requested to re-enter the request from the client device. This architecture increases the efficiency of the whole information processing system.

In addition, when another new web service is added to provide the web service belonging to the same service area, the server device 20 of the present invention can use the new web service simply by updating the provider database 251 and the field mapping database 253. In this case, there is no need to create a separate template for the newly added web service but the template used in the existing web service can be used without change.

The server device 20 in this embodiment, which acquires the policy file 266 from the web service providing device 30, eliminates the need for setting a condition in advance for the input data as in the conventional system. Therefore, the server device 20 can save time and labor required for the setting, thus ensuring efficiency even when the server device 20 works with many web service providing devices 30 or accepts many types of data. The server device 20 can also ensure flexibility even when the policy is changed on the web service providing side.

The server device 20 in this embodiment generates page source data that includes a hint indicating a condition for the data entered on the screen. Therefore, the user can easily understand what data must be entered to meet the condition.

The server device 20 in this embodiment can insert a check module into the page source data to allow the check module to be executed on the client device 10 side for checking if the user-entered data satisfies the policy. This reduces the processing load required for the server device 20 side to check the entered data.

When the policy for the request data is isIn( ) that limits the acceptable value of the request data to a set of predetermined selections, the server device 20 in this embodiment can insert the <select>tag into the page source data to display a list box that allows the user to select one of the selections specified in the policy. Therefore, the user can enter the request data correctly from one of the specified selections.

The server device 20 in this embodiment stores the correspondence between the name of request data included in a SOAP message and the name assigned to an input field in the field mapping database 253 for managing the correspondence, there is no need to use the same name for them. Therefore, the programmers and screen designers working on the development of the information processing service in the server device 20 can design the screen and develop application programs without worrying about the names of data that will be sent to the web service providing device 30. In addition, even when the name of necessary request data is changed on the web service providing side, the various web services can respond to the change by simply updating the field mapping database 253 without changing the application programs running on the server device 20.

Although the information processing system that provides the information processing services for hotel booking is described in this embodiment, the present invention is not limited to this system. For example, the present invention can be applied to various types of information processing services that use web services such as online shopping, the ticket purchase service, and the on-demand video data and music data distribution service.

Although the policy is managed in this embodiment as a file which is separated from the interface definition of the web services such as WSDL, the policy may also be described in the interface definition.

Although the client device 10 accesses the server device 20 via a web browser in this embodiment, the client device 10 in this present invention may access the server device 20 not only via the browser but also via any application program.

The server device 20 acquires the policy file 266 from the web service providing device 30 in this embodiment each time the server device 20 receives a screen acquisition request, for which the service ID is specified, from the client device 10. Instead of this, the policy file 266 acquired from the web service providing device 30 may also be stored in a database of the service device for a predetermined period of time. Storing the policy file 266 in a database reduces the number of accesses to the web service providing device 30 and increases the processing efficiency of the information processing service.

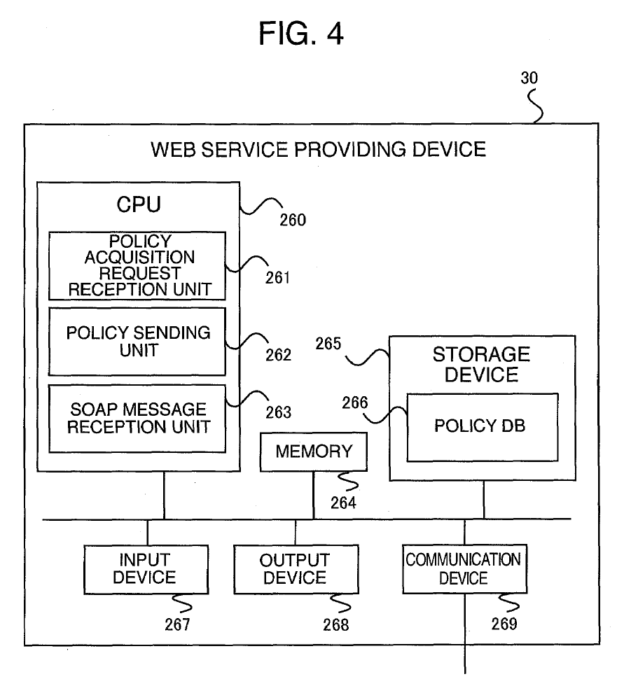

FIG. 4 shows an example of the block diagram of the web service providing device 30. The web service providing device 30 comprises a policy acquisition request reception unit 261 that accepts a policy acquisition request from the server device. A storage device 265 has a policy database 266 that stores, as a policy, the data input condition that is necessary when accepting a service request of the service provided by the web service providing device 30. When the web service providing device provides multiple services, the web service providing device may also comprises a policy selection unit that selects a policy, corresponding to the desired service, from the policy database based on the information specifying the type of service, such as a service ID, included in a policy acquisition request. The web service providing device 30 further comprises a policy sending unit 262 that sends a policy to the server device in response to a policy acquisition request and a SOAP message reception unit 263 that receives a service request as well as information necessary for providing the service.

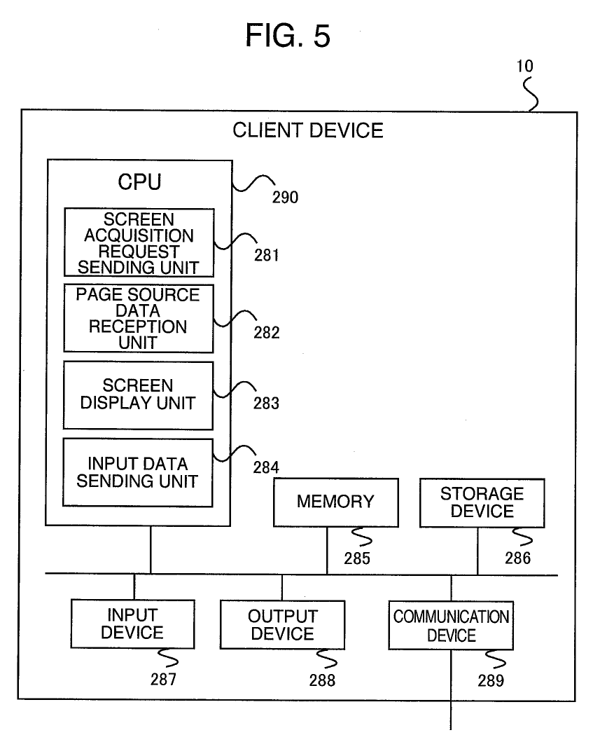

FIG. 5 shows an example of the block diagram of the client device 10. The client device 10 comprises a screen acquisition request sending unit 281, a page source data reception unit 282, a screen display unit 283, and an input data sending unit 284. Each processing unit is usually installed in a PC or a PDA as a program that operates like a web browser. The screen acquisition request sending unit 281 requests the server device 20, via a communication device 289, to send a web service list display screen, and the page source data reception unit 282 receives page source data via the communication device 289. The received page source data is displayed on an output device 288, such as a display, by the screen display unit 283. The input data sending unit 284 sends information, entered by the user from an input device 287, to the server device 20. The screen acquisition request sending unit 281, the page source data reception unit 282, the screen display unit 283, and the input data sending unit 284 may be implemented as the programs executed in a CPU 290 or may be implemented as hardware.

### ==Modification==

In the information processing system in this embodiment described above, it is assumed that there is a one-to-one correspondence between fields in the input form on the screen displayed on the client device 10 and request data included in a SOAP request accepted by the web service providing device 30. It should be noted that the present invention may also be applied to a case in which, instead of a one-to-one correspondence, there is a correspondence between a value calculated from multiple fields and request data.

In this case, the server device 20 stores the name of a value (hereinafter called a virtual field), which can be calculated from multiple input fields through some calculation, and the information (hereinafter called an entity), which indicates the calculation method for calculating the virtual field from the input fields, in the field definition database 252 for management purposes. FIG. 26 shows an example of another architecture of the field definition database 252 used in this case. As shown in the figure, the field definition information stored in the field definition database 252 includes the field name 2522 and the display name 2523 as well as an entity 2524 indicating the calculation method for calculating the value of the field name 2522. In this example, “cat(N,M)” indicates the concatenation between the character string of the field N and the character string of the field M. That is, the field definition shown in FIG. 26 indicates that the character string generated by concatenating the value of the “bookingForm.FirstName” field and the value of the “bookingForm.LastName” field is the value of the “bookingForm.FullName” virtual field.

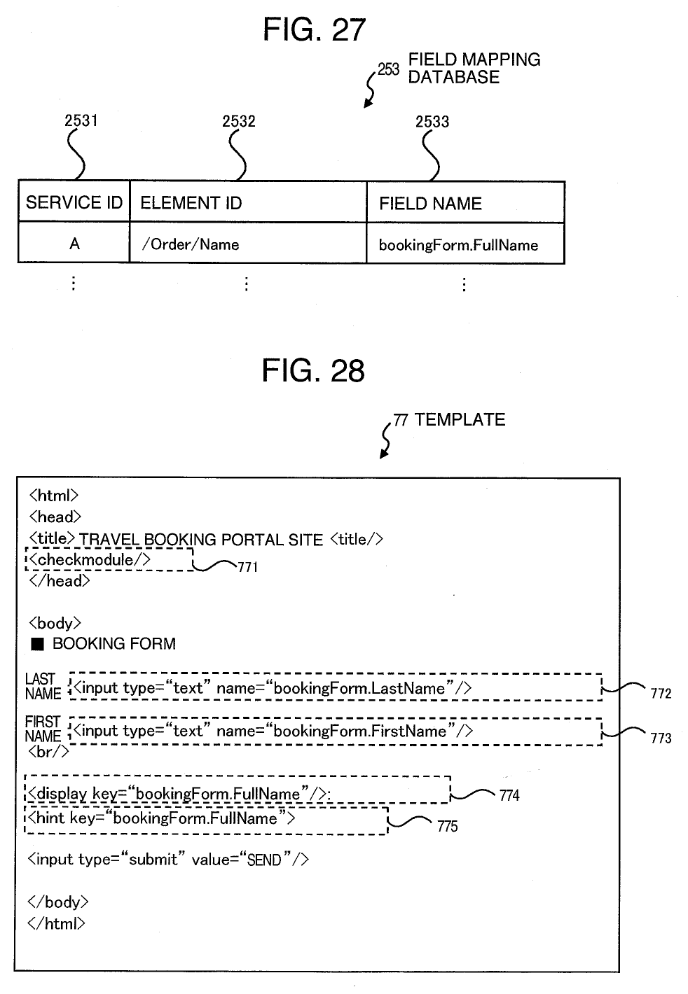

In this case, the server device 20 adds two modules during the <checkmodule>tag replacement processing described before in FIG. 21: one is a module that performs calculation to calculate the virtual field from the input fields and the other is a check module generated by specifying the virtual field for the argument of the program described in the check module 2543 of the input assist pattern database 254. For example, if the field mapping information is registered indicating that the request data included in the SOAP message identified by “Order/Name” corresponds to “bookingForm.FullName” as shown in FIG. 27, the server device 20 calculates the value of the virtual field “BookingForm.FullName” from the “bookingForm.FirstName” field and the “bookingForm.LastName” field in the example shown in FIG. 26 and, then, adds the check module generated by specifying the calculated virtual field “bookingForm.FullName” for the argument of the check module “maxLength( )”.

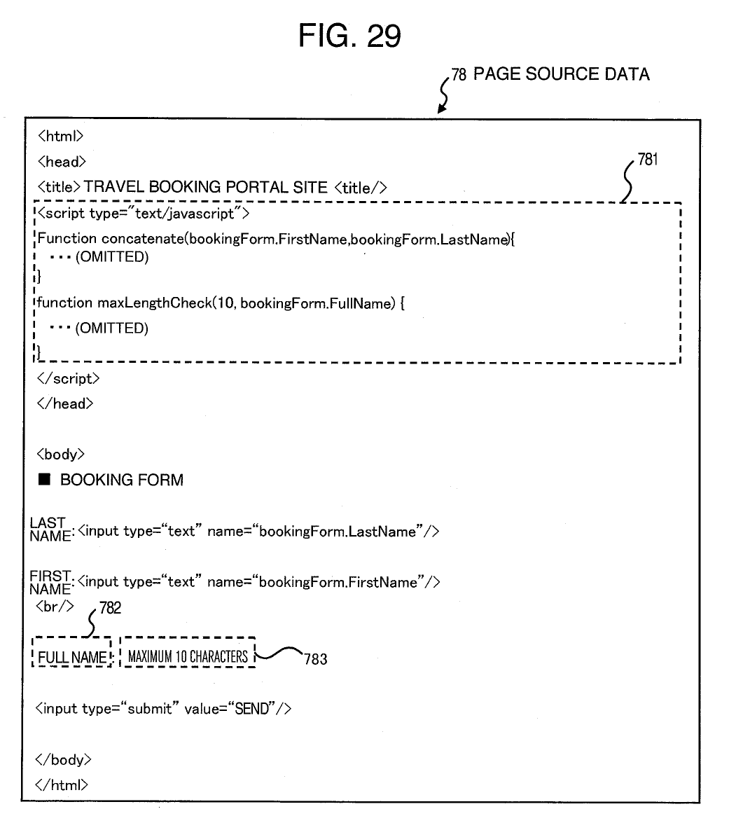

FIG. 28 shows an example of the template used for this operation, and FIG. 29 shows an example of the generated page source data. Assume that, as shown in FIG. 28, a template 77 includes a <checkmodule>tag 771, an <input>tag 773 that indicates the input field of “FirstName” and an <input>tag 772 that indicates the input field of “LastName” (these two fields correspond to “FullName”), a <display>tag 774, and a <hint>tag 775. FIG. 29 shows page source data 78 generated by the processing of the server device 20 described above. In the page source data 78, the <checkmodule>tag is replaced by the following two: one is the field where the value of the virtual field “bookingForm.FullName” is calculated as the concatenation of the “bookingForm.FirstName” field and the “bookingForm.LastName” field and the other is the function “maxLengthCheck( )” which is described in the check module 2543 of the input assist pattern information and for which the arguments are specified (the arguments are “10” included in the constraint “maxLength(10)” corresponding to “/Order/Name” specified in the policy file 266 and “bookingForm.FullName” calculated by the calculation described above). The <display>tag 774 is replaced by a character string 782 “Full name” that is the display name 2523 corresponding to the field name 2522 of “bookingForm.FullName”, and the <hint>tag 775 is replaced by a character string 783 “Maximum 10 characters” that is the hint 2542 of the input assist pattern information corresponding to “maxLength(10)”.

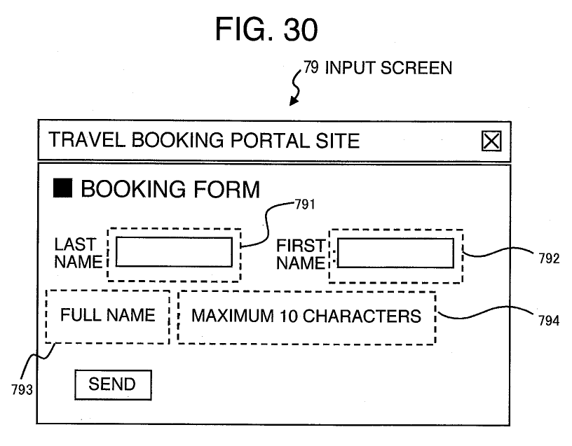

FIG. 30 shows an example of an input screen 79 displayed by the client device 10 based on the page source data 78. The input screen 79 has an input field 791 for the last name corresponding to “bookingForm.Lastname” and an input field 792 for the first name corresponding to “bookingForm.FirstName”. On the input screen 79, a display name 793 and a hint 794 corresponding to “bookingForm.FullName” are displayed. The data entered into the input field 791 and the input field 792 on the input screen 79 is sent to the server device 20 with the former associated with “bookingForm.LastName” and the latter associated with “bokkingForm.FirstName” respectively. The server device 20 concatenates the input data corresponding to “bookingLastName” and the input data corresponding to “bookingFirstName” to create request data and creates a SOAP message with the created request data associated with “bookingForm.FullName”.

When data entered into multiple input fields is concatenated to generate one piece of request data as described above, a program or a hint for satisfying the condition for the concatenated request data may be inserted into the page source data. In this case, processing can be performed flexibly even if there is no one-to-one correspondence between the request data specified in the SOAP message and the screen input fields.

Although the entity 2524 is described in the above modification as the function “cat(N,M)” that indicates the concatenation of the character strings in the field name 2522, a function that performs another calculation may also be used. For example, if the field N and the field M are numeric value fields, the function “add(N,M)” that indicates the addition may be used. In addition to the functions described above, any function can be used to associate the request data with the input fields more flexibly.

While the embodiments have been described, it is to be understood that the embodiments described above are merely illustrative of and not restrictive on the present invention. The present invention may be modified or changed without departing from the spirits thereof and includes the equivalents thereof.

1. A page source data generation method for generating page source data for displaying a screen having input fields in which request data is entered, said request data being data sent to a service providing device that provides a web service, said page source data generation method, performed by an information processing device that generates page source data, comprising the steps of:
storing field names in a memory with the field names associated with request data names, said field names being information identifying the input fields, said request data names being information identifying the request data;
storing policy data, in which the request data names and conditions for the request data are included, in said memory;
reading the field names, associated with the request data names included in the policy data, from said memory; and
generating the page source data, to which information that helps a user to enter input data is added, so that the user enters the input data satisfying the conditions in the input fields identified by the field names that were read.

2. The page source data generation method according to claim 1, wherein the conditions are described in the policy data in a first representation format, said page source data generation method, performed by said information processing device, further comprising the steps of:
storing screen representation data in said memory with policy representation data associated therewith, said screen representation data being the conditions described in a second representation format used for displaying on the screen, said policy representation data being the conditions described in the first representation format;
reading the screen representation data, associated with the policy representation data included in the policy data, from said memory; and
generating the page source data to which the screen representation data that was read is added.

3. The page source data generation method according to claim 1, said method, performed by said information processing device, further comprising the steps of:
storing programs in said memory with said programs associated with information indicating the conditions, said programs being executed in an information processing device, which displays the screen, to determine if the input data satisfies the conditions;
reading the programs, associated with information indicating the conditions included in the policy data, from said memory; and
generating the page source data to which the programs, which were read, are added.

4. The page source data generation method according to claim 1,
if the condition included in the policy data limits a value of the request data to any of predetermined selections, said page source data generation method, performed by said information processing device, further comprising the step of generating the page source data to which data is added to display the input field via which a selection is made from a list of the selections.

5. The page source data generation method according to claim 1, further comprising:
sending an acquisition request for the policy data to said service providing device;
receiving the policy data sent from said service providing device in response to the acquisition request; and
storing the received policy data in said memory.

6. The page source data generation method according to claim 1, said method, performed by said information processing device, further comprising the steps of:
storing the request data names and a virtual field name into said memory with the request data names associated with the virtual field name, said virtual field name being information indicating a plurality of the field names;
reading the virtual field name, associated with the request data names included in the policy data, from said memory; and
generating the page source data, to which the information that helps the user is added, for each of the field names indicated by the virtual file name that was read so that the user enters the input data satisfying the conditions in the input fields indicated by the field names that were read.

7. The page source data generation method according to claim 3, wherein said information processing device has templates for creating the page source data, said method further comprising the step of replacing extension tags, included in the templates, by the programs.

8. The page source data generation method according to claim 4, wherein said information processing device has templates for creating the page source data, said method further comprising the step of replacing an extension tag, included in the templates, by data for displaying the input fields for selecting from the list of the selections.

9. A program for generating page source data for displaying a screen having input fields in which request data is entered, said request data being data sent to a service providing device that provides a web service, said program causing an information processing device to perform the steps of:
storing field names in a memory with the field names associated with request data names, said field names being information identifying the input fields, said request data names being information identifying the request data;
storing policy data, in which the request data names and conditions for the request data are included, in said memory;
reading the field names, associated with the request data names included in the policy data, from said memory; and
generating the page source data, to which information that helps a user to enter input data is added, so that the user enters the input data satisfying the conditions in the input fields identified by the field names that were read.

10. The program according to claim 9, wherein the conditions are described in the policy data in a first representation format, said program further causing said information processing device to perform the steps of:
storing screen representation data in said memory with policy representation data associated therewith, said screen representation data being the conditions described in a second representation format used for displaying on the screen, said policy representation data being the conditions described in the first representation format; and
reading the screen representation data, associated with the policy representation data included in the policy data, from said memory,
wherein, in the step of generating the page source data, said program causes said information processing device to generate the page source data to which the screen representation data is added.

11. The program according to claim 9, said program further causing said information processing device to perform the steps of:
storing modules in said memory with said modules associated with information indicating the conditions, said modules being programs executed in an information processing device, which displays the screen, to determine if the input data satisfies the conditions; and
reading the modules, associated with information indicating the conditions included in the policy data, from said memory,
wherein, in the step of generating the page source data, said program causes said information processing device to generate the page source data to which the modules are added.

12. The program according to claim 9,
wherein, if the condition included in the policy data limits a value of the request data to any of predetermined selections in the step of generating the page source data, said program further causing said information processing device to perform the step of generating the page source data to which data is added to display the input field via which a selection is made from a list of the selections.

13. An information processing system for generating page source data for displaying a screen having input fields in which request data is entered, said request data being data sent to a service providing device that provides a web service, said information processing system comprising:
a mapping database that stores field names with the field names associated with request data names, said field names being information identifying the input fields, said request data names being information identifying the request data;
a policy data storage unit that stores policy data, in which the request data names and conditions for the request data, are included; and
a page source data generation unit that reads the field names, associated with the request data names included in the policy data, from said mapping database and
generates the page source data, to which information that helps a user to enter input data is added, so that the user enters the input data satisfying the conditions in the input fields identified by the field names that were read.

14. The information processing system according to claim 13, wherein the conditions are described in the policy data in a first representation format, said information processing system further comprising:
a hint database that stores screen representation data with policy representation data associated therewith, said screen representation data being the conditions described in a second representation format used for displaying on the screen, said policy representation data being the conditions described in the first representation format; and
a screen representation data acquisition unit that reads the screen representation data, associated with the policy representation data included in the policy data, from said hint database,
wherein said image data generation unit generates the page source data to which the screen representation data that was read is added.

15. The information processing system according to claim 13, further comprising:
a program storage unit that stores programs with said programs associated with information indicating the conditions, said programs being executed in an information processing device, which displays the screen, to determine if the input data satisfies the conditions; and
a program acquisition unit that reads the programs, associated with information indicating the conditions included in the policy data, from said program storage unit,
wherein said page source data generation unit generates the page source data to which the programs, which were read, are added.

16. The information processing system according to claim 13,
wherein, if the condition included in the policy data limits a value of the request data to any of predetermined selections, said page source data generation unit generates the page source data to which data is added to display the input field via which a selection is made from a list of the selections.
